(19) United States
(12) Patent Application Publication
(10) Pub. No.: US 2007/0136499 A1
(43) Pub. Date: Jun. 14, 2007

(54) Method for designing a completely decentralized computer architecture

(76) Inventor: Charles Edward Sykes, Leon (MX)

Correspondence Address: Charles E. Sykes, P.O. Box 38523, Sacramento, CA, 95838, US

(21) Appl. No.: 11/299,709

(22) Filed: Dec. 12, 2005

(51) Int. Cl. G06F 13/00

(52) U.S. Cl. 710/100

(57) ABSTRACT

A design for a computer architecture that has been decentralized to a maximum extent to provide for increased system throughput, enhanced system security and stability while, at the same time, decreasing complexity within the system. The design includes a multitude of specially designed processing units, a bus system which has buses specially designed for interconnecting all of the processing units, and a set of operations that are designed to work in such a system. Each processing unit is designed to be programmed to do one small part of the computing task, each processing unit taking its turn, one after another, until the task is complete. Most of the buses are designed to be split up into smaller sections by the use of software thereby isolating sections of the processing units into groups, each with its own small section of the buses. Each isolated group of processing units can then be assigned a process to handle without interference to, or from, any other process within the system. A bus that is not split up into smaller sections provides for communication between processes. Included is a set of operations that are designed to maximize the potential for processing, control, and storage in such a design.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

1. Field of Invention

This invention relates to the design of computer architectures.

2. Prior Art

Ever since the first computing machines were built an ongoing search has existed by those who design and build them to find ways to increase the amount of work, the throughput, which can be achieved by the machines within a given amount of time. The computer industry has tried many innovations in the search for greater throughput but the basic design of a computer is still as the original pioneers of the concept envisioned it.

The basic architecture used in the computers of today, whether they are small handheld machines or the huge supercomputers, is basically what's called ‘Von Nuemann Architecture.’ It consists of the idea that a computer has basic elements that must always be present. These elements are the processing unit, the control unit, and the memory unit and some would add the elements of input and output. Innovations have all sought to manipulate these elements to achieve greater throughput but all have failed to overcome what has come to be called the ‘Von Nuemann Bottleneck.’ This problem arises from the memory being separate from the processing and control unit. Because it is separate all code and data must be brought from memory to the processing and control unit and then put back into memory after use. This movement of data and code back and forth over a bus structure of limited capacity is referred to as the ‘Von Nuemann bottleneck.’ The innovations have all increased throughput, but they still suffer from the same basic limitations imposed by the physical manufacturing constraints of an earlier era. When computers were first constructed as electronic devices the industry used vacuum tubes, chassis for mounting components on, and circuits were built from physically discrete components. Now the industry uses manufacturing techniques that lay down millions of components upon a substrate at minimal cost. And, yet, after all this time the original manufacturing constraints are adhered to. The idea persists that memory is somehow different from, merely a resource for, the processing and control unit. Originally it was separated from processing and control because of cost constraints. The constraints are very different today and yet the essential elements of a computer still are not fully integrated within computing systems.

The industry still adheres to this separation of the elements needed for a computing machine. The many innovations have all sought to grapple with the problem of the memory being separate from and slower than the processing and control unit. Direct memory access, caches, pipelining, virtual memory, RISC architecture, the Harvard architecture, etc. have all sought to overcome this limitation. All these methods have succeeded to some degree, but the basic limitation still exists. None of these methods have integrated memory, processing, and control to a degree sufficient enough to overcome the bottleneck and its effect upon throughput. Though some claim a decentralized architecture, none have truly done so. A truly decentralized architecture will have all computing elements fully integrated and evenly spread out through the whole system.

The most recent innovations within the industry take a different approach, but it is not different enough to overcome the limitations of not having the elements fully integrated. The division of the resources of a system among several different processors, while a step in the right direction, still fails to integrate the elements. With these designs, as well as the ‘core’ designs that are emerging, the memory is still a separate element from the processing and control element. Some designs will give each processor or group of processors an exclusive section of memory, or a special fast section of memory, but they still keep the memory separate from the processing and control unit. This failure to integrate memory with the other basic computing functions along with the failure to truly decentralize system architecture are what create the ‘Von Nuemann bottleneck’ and a host of other limitations that exist in modern computing systems.

### BACKGROUND OF THE INVENTION—OBJECTS AND ADVANTAGES

The objects and advantages of this invention are:
a. to provide for full integration of memory, processing, and control within a multitude of decentralized processing units, each of which has the capability to process data, perform process or system control functions, and will act as a memory unit;
b. to provide for maximum possible decentralization within a computer system by the even and uniform distribution of system functions amongst a multitude of decentralized processing units;
c. to provide the ability to equably apportion system resources between processes so that each process has a portion of the decentralized processing units and associated bus lines for its exclusive use;
d. to provide for the easy expansion of the systems' resources by the simple addition of bus extensions with associated decentralized processing units;
e. to provide increased system throughput by the ability of many processes to run simultaneously within their own apportioned section of the systems' resources;
f. to provide for increased system security by the physical isolation of processes within their own apportioned section of the systems' resources;
g. to provide for increased system stability by the physical isolation of processes within apportioned sections so that processes are unable to affect each other except by transmitting messages over the I/O bus.
h. to provide for increased simplicity and uniformity in system design by the use of a multitude of similar units to serve as system resources;
i. to provide for increased simplicity in system and application programming by providing a system that is inherently more stable and secure.

### SUMMARY

Presented is a method of designing a fully decentralized computer architecture that provides a method of apportioning out system resources among multiple processes that run simultaneously within the system.

### DRAWINGS—FIGURES

FIG. 1 of 9—This is an simplified view of the design of the system showing groups of decentralized processing units that are interconnected by the bus structures that are not apportionable and other bus structures that are apportionable.

FIG. 2 of 9—This is a detailed view showing the necessary components of the apportioning switch blocks, 18 in FIG. 1 of 9.

FIG. 3 of 9—This details the interconnections between all the DPUs, decentralized processing units, within an apportioned section. Apportioned sections are groups of DPUs, 10 in FIG. 1 of 9, which have been isolated from other groups of DPUs.

FIG. 4 of 9—This drawing shows the relationship and the flow of data between a DPU 26 and the bus structures.

FIG. 5 of 9—This shows the details of the control section, 27 in FIG. 4 of 9, of a DPU.

FIG. 6 of 9—This drawing shows the details of the processing section 28 of a DPU.

FIG. 7 of 9—This figure shows the set of operations, the opcodes, to be used in programming with a system using this design.

FIG. 8 of 9—This is an example of a simple algorithm implemented with the set of operations as shown in FIG. 7 of 9.

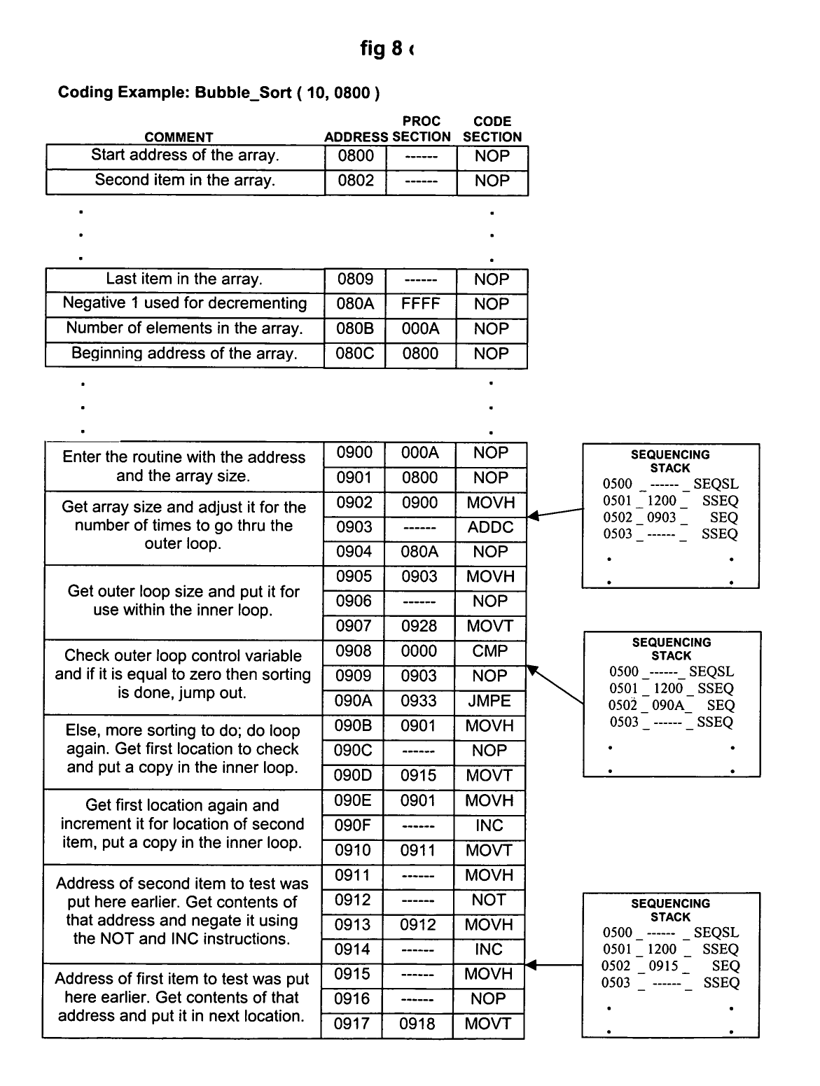

FIG. 9 of 9—This is a continuation of FIG. 8 of 9.

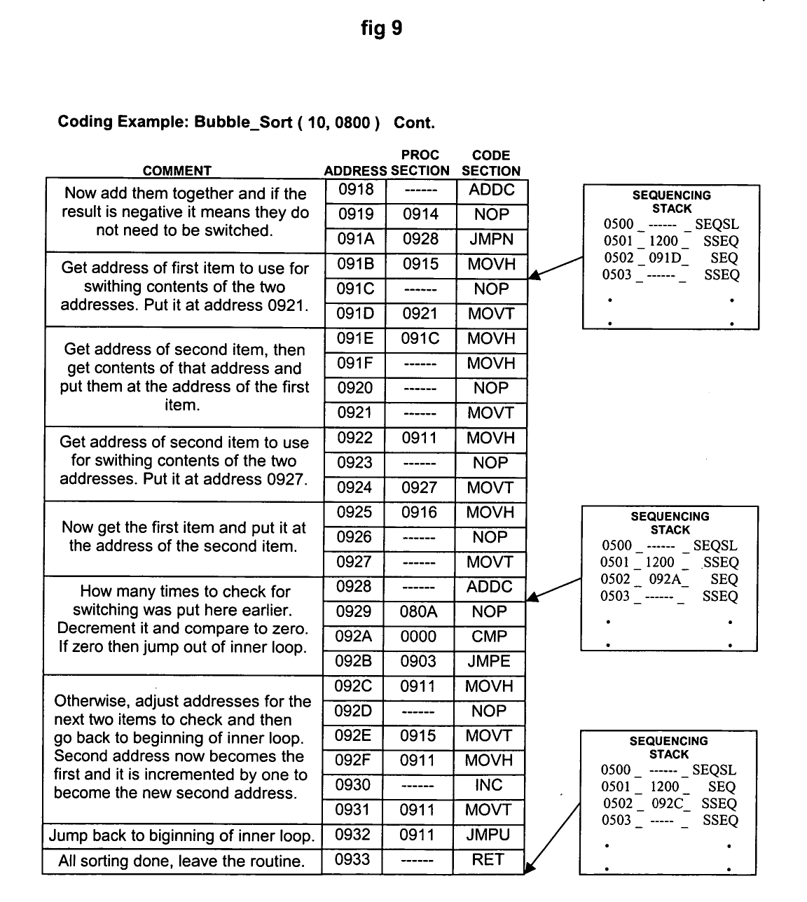

### DRAWINGS—NUMBER REFERENCES

10 - group of decentralized processing units
11 - primary address bus
12 - secondary address bus
13 - data bus
14 - auxiliary data/control bus
15 - bilateral control bus
16 - I/O bus
17 - global control bus
18 - apportioning switch block
19 - address decoder
20 - AND gate
21 - switch state latch
22 - switch driver circuits
23 - switches
24 - BASID control line
25 - BASS control line
26 - decentralized processing unit
27 - control section
28 - processing section
29 - internal signal flow
30 - opcode latch
31 - decoder circuits
32 - ALU
33 - data latch
34 - data flow controler

### DETAILED DESCRIPTION

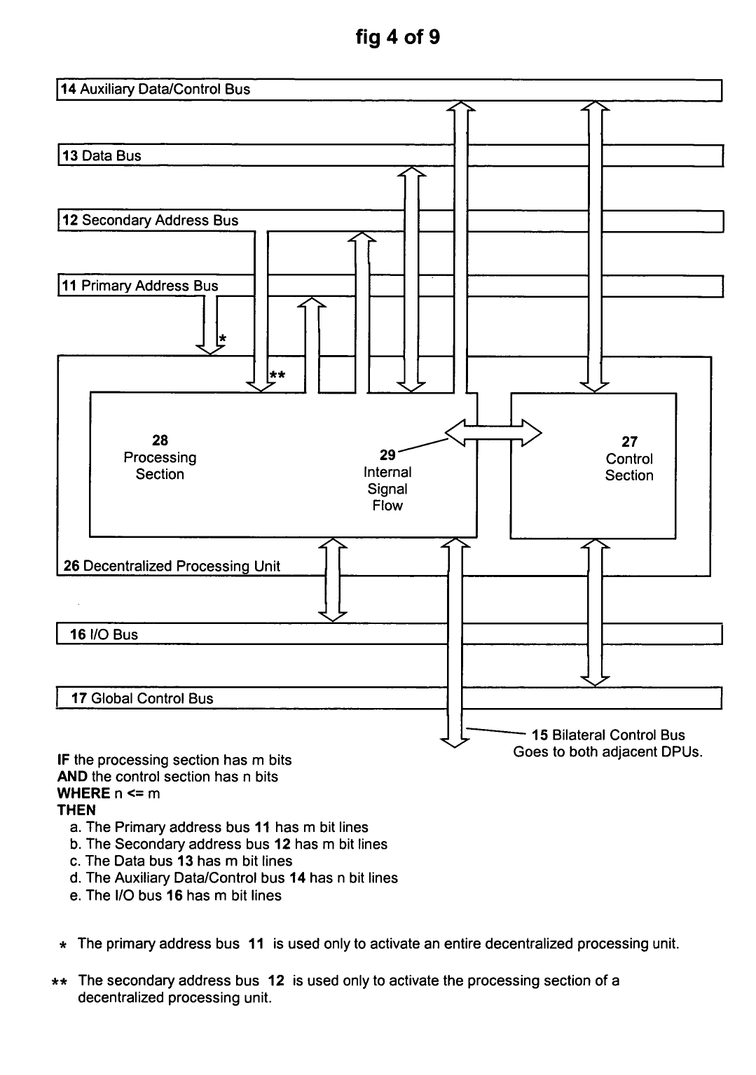

The preferred embodiment of this method of designing a completely decentralized architecture for a computer system includes details that are organized as follows:
Decentralized Processing Units—FIG. 4 of 9

Function and Design of DPUs

Control Section of DPUs

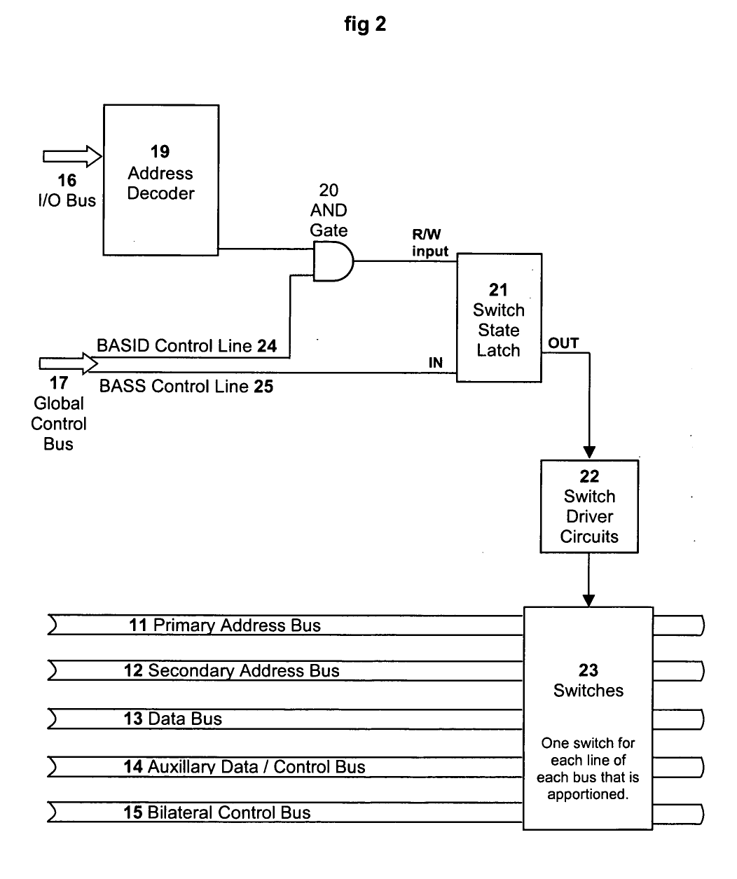

Processing Section of DPUs
Apportioning Switches—FIG. 2 of 9

Function and Design

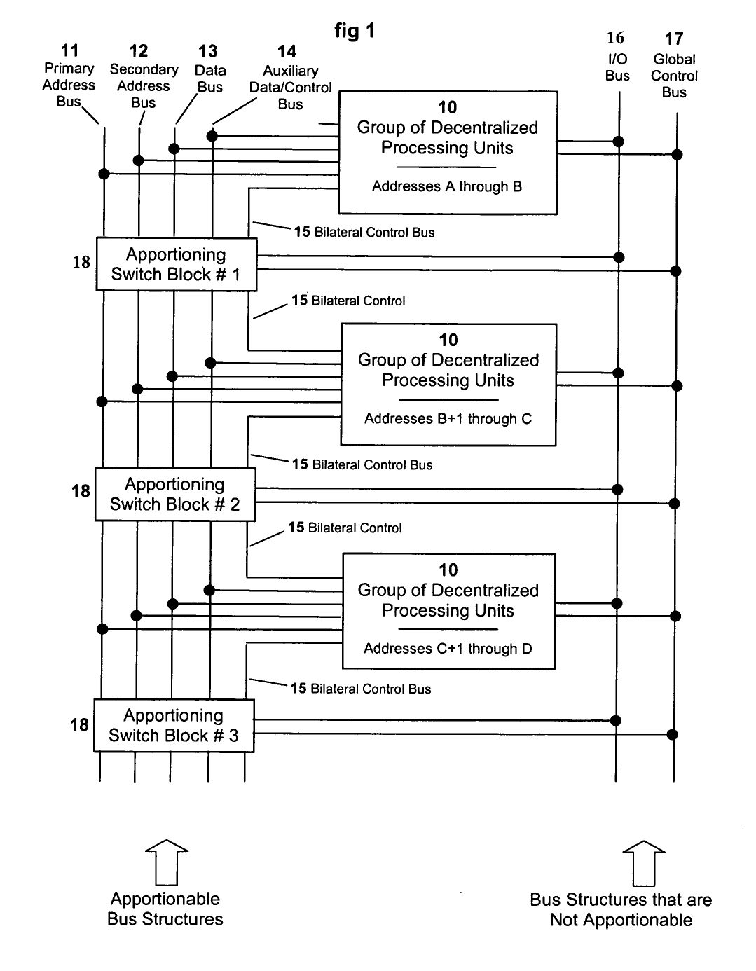

Method of Controlling Switches
Bus System—FIG. 1 of 9

Function and Design

Apportionable Bus Structures

Non-apportionable Bus Structures

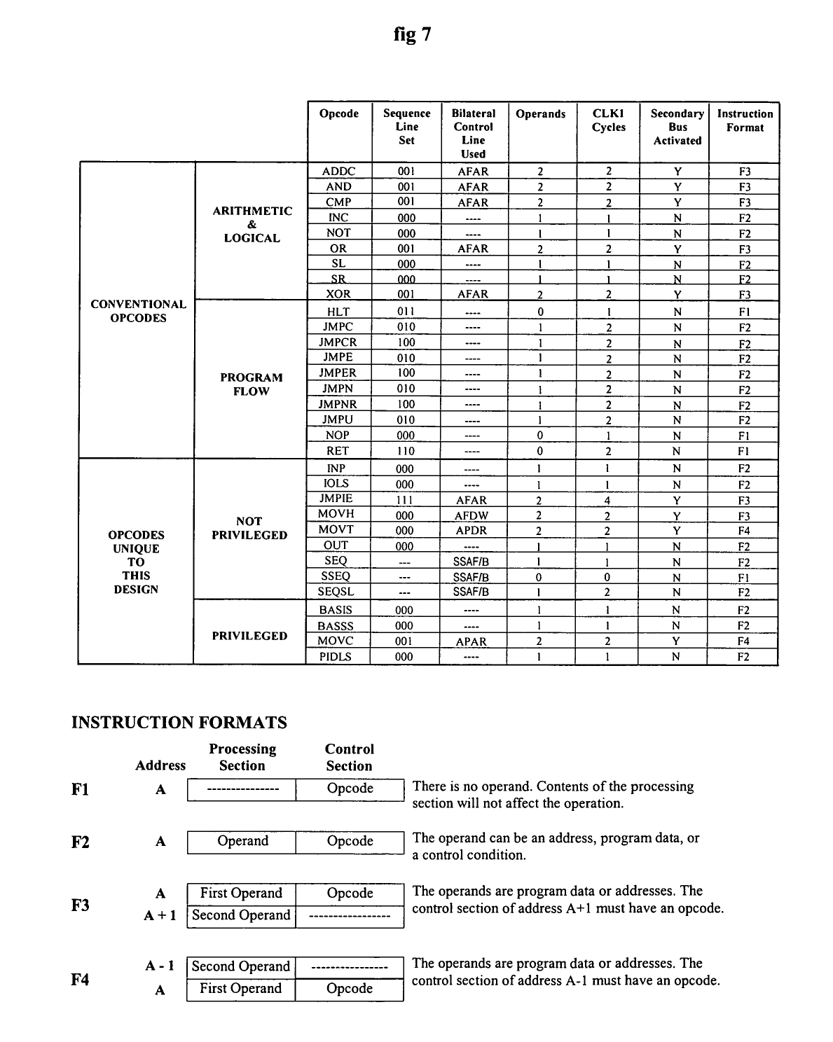

Bilateral Control Bus Lines
Set of operations—FIG. 7 of 9

Overall design

Opcodes standard to industry

Opcodes unique to this design

Privileged opcodes
Supporting Structures
Operation
Alternate Embodiments
Conclusion

### Decentralized Processing Units—Function and Design

Refer to FIG. 4 of 9. The function of a decentralized processing unit 26, hereafter referred to as a DPU 26, is to handle all of the processing, control, and memory functions that are needed within the computer. No single DPU 26 is more functional than any other DPU but they do not all share the same function. While most DPUs 26 are identical in capability and design, not all are. Collectively, all DPUs work together to handle all the functions that a central processing unit handles in computers that are in common use today.

Refer to FIG. 7 of 9 except as noted. Each DPU is designed to hold one instruction from the set of instructions. The instruction is programmable with the use of software. A DPU can only handle one instruction at a time. To handle a different instruction it must be reprogrammed. Each instruction may have zero, one, or two operands. Each instruction will also have a result. The result can be a piece of data that needs to be held until needed, or it can be a control action of some sort. Each DPU can hold one operand for an instruction before the operation. After the operation it can be holding the original operand or the result of the operation if the result is a data object.

In this design there are four types of DPUs. The majority of the DPUs in the system will be able to handle any single instruction except the SEQ, SSEQ, or SEQSL instructions. Another DPU is designed to handle the SEQ, SSEQ, and SEQSL instructions only. The DPUs designed specifically to handle these three instructions handles all the sequencing within a process. Sequencing is the act of controlling the order in which each of the DPUs is activated to do its part of the program. In all of the text that follows a DPU that is designed to handle the SEQ, SSEQ, and SEQSL instructions will always be referred to as a sequencing DPU or sequencer. A DPU designed to handle any of the other instructions will just be referred to as a DPU. The third and fourth types of DPUs within the system are either of the first two types with the added condition that they have their opcodes built in as read only. They are not programmable with the use of software and are used for booting the system.

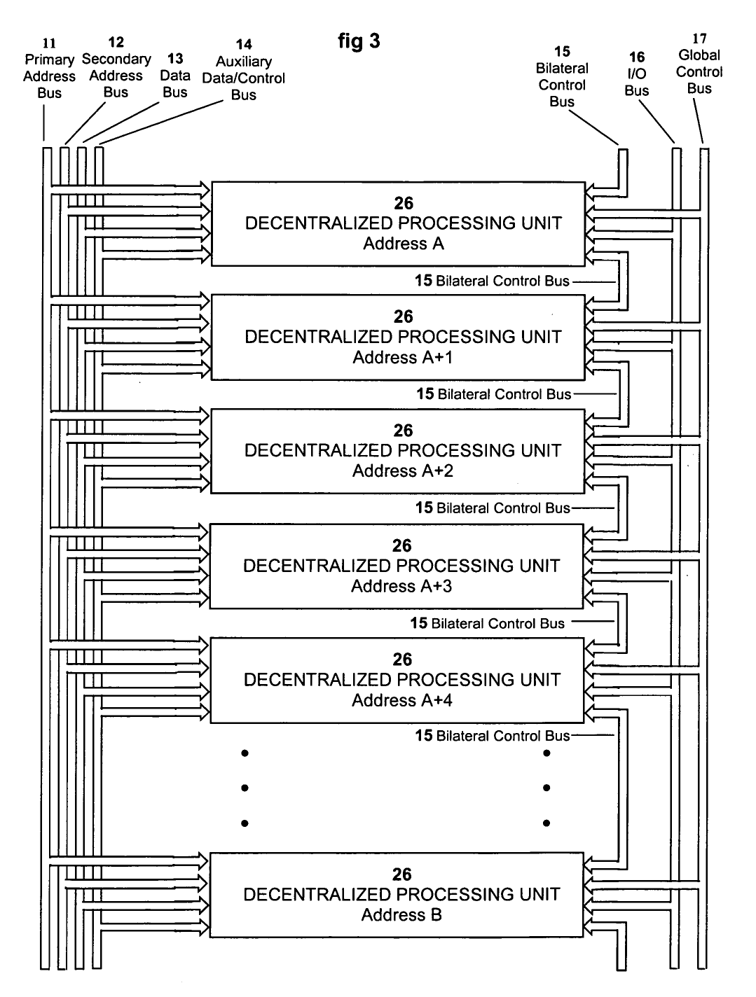

All DPUs, 26 in FIG. 3 of 9, are referenced with a unique address. All DPUs are logically organized so that their addresses are linearly arranged. Logically, address one is followed by address two, which is followed by address three, etc, all the way up to the highest address. Refer to FIG. 4 of 9. Each address uniquely refers to the entire DPU 26, but each address can be used to activate either of the two sections of the DPU, the control section 27 or the processing section 28. If the address appears on the primary address bus 11 then the control section is activated which in turns activates the entire DPU. If the address appears on the secondary address bus 12 then only the processing section 28 will be activated for the reading or writing of data. Two different instructions enable a DPU to be self-activated, meaning that they do not need activation by either the primary 11 or secondary 12 address buses. In addition it is possible to activate the processing section 28 of a DPU with any one of the four different bilateral control lines of the bilateral control bus 15.

Each DPU can hold program data and program code. Program data and program code are kept separate. Program data can be operands, addresses, or any other data object that is used by the program code. Program codes are the instructions that tell the DPUs what actions to take. One of the privileged instructions is used to enable a process, the operating system, to handle program code as program data. Except for that instruction there is no way for program data and program code to get mixed up. The program data is kept in the processing section 28 of a DPU. The program code is kept in the control section 27.

### Decentralized Processing Units—Control Section

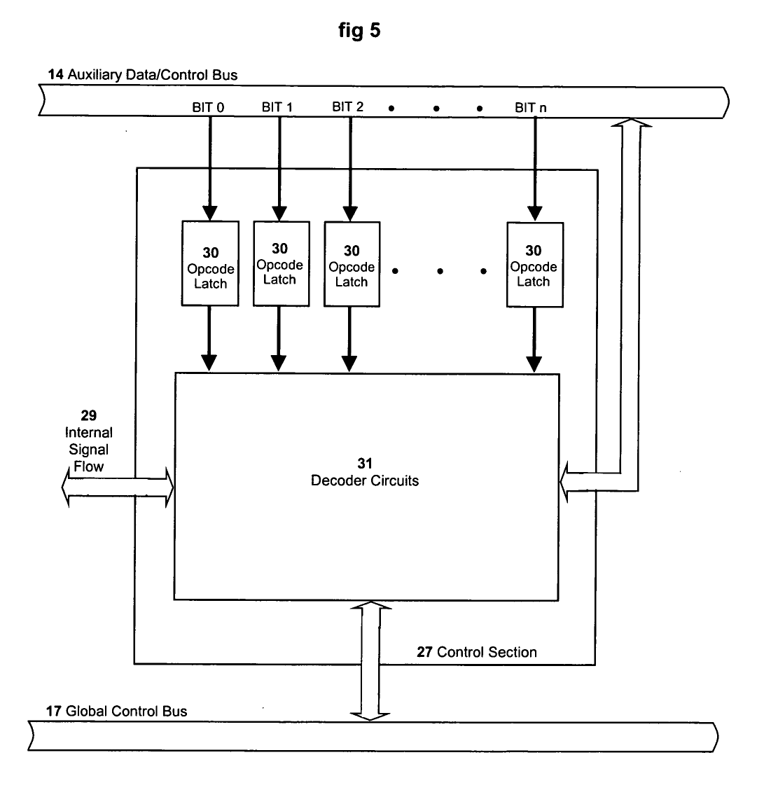

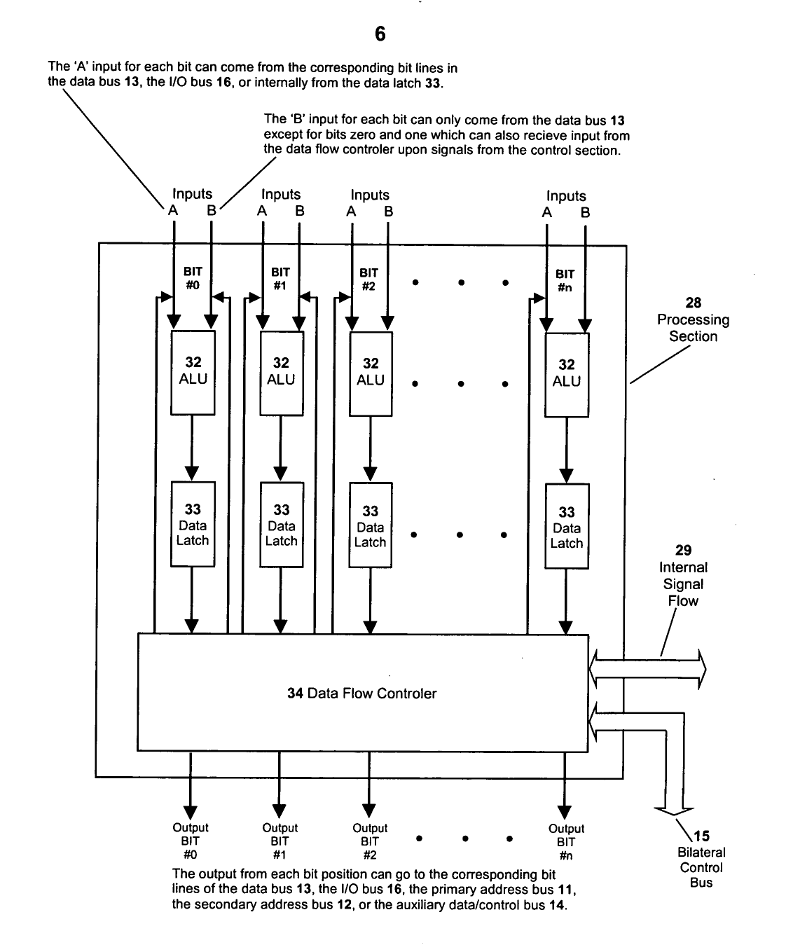

Refer to FIG. 5 of 9 except as noted. The control section 27 of a DPU is used for all functions except the processing and storage of program data. The control section 27 is composed of opcode latches 30 and decoder circuits 31. The latches 30 hold the opcode that has been programmed into the DPU. The decoder 31 generates all the necessary control signals. The control section has a latch 30 in each bit position. The number of bit positions in the control section does not exceed the number of bit positions within the processing section, 28 in FIG. 6 of 9. This number of bit positions is also equal to the number of lines in the auxiliary data/control bus 14.

For each bit position there is a latch 30 to hold that corresponding bit of the opcode. The input to each latch 30 comes from the corresponding bit line of the auxiliary data/control bus 14. That data is put there via the use of the MOVC instruction during the loading of the process, the programming of the DPUs. The data in the latches 30, the opcode, stays there until the DPU is reprogrammed or power is lost. The output of each of the latches 30 goes directly to the decoder circuits 31.

The decoder circuits 31 accept all the necessary inputs, decodes them, and then produces the correct set of output signals. It is the main component within the control section. Inputs to the decoder come from the opcode latches 30, the auxiliary data/control bus 14, the global control bus 17, and the internal signal flow 29 from the processing section. The decoder 31 outputs signals to the processing section, 28 in FIG. 6 of 9, to the global control bus 17, and to the auxiliary data/control bus 14. Depending on the output signals generated by the decoder 31 one or more of the following actions can be initiated by the control section of a DPU. Refer to FIG. 4 of 9.
A logical, arithmetic, or data movement operation is performed within the processing section 28.
An address is put onto the primary or secondary address bus causing activation of an entire DPU 26 or just the processing section 28 of a DPU.
The processing section of one of the two adjacent DPUs is activated for reading or writing.
Control lines are set high or low.
Data is put onto or read from the data bus 13, auxiliary data/control bus 14, or the I/O bus 16.
   In addition, the above actions could in themselves cause other actions to occur.

A DPU designed for sequencing has a control section that differs from the control section of a regular DPU. Being specifically designed for sequencing there is no need for them to be programmable or to be able to decode all the possible opcodes. They do need to be able to decode the state of the four sequence control lines in addition to the other control lines. A sequencing DPU also needs to function with all other sequencing DPUs within the apportioned section to handle all matters relating to the sequencing stack.

### Decentralized Processing Units—Processing Section

Refer to FIG. 4 of 9 except as noted. The purpose of the processing section 28 is to store and process program data. It can also store data that is needed for control purposes. When a DPU is activated by the primary address bus 11 the control section 27 is activated first and this in turn activates the processing section 28. In such a case the processing section 28 will carry out the function dictated to it by the control section 27. It receives its signals from the decoding circuits, 31 in FIG. 5 of 9, via the internal signal flow 29 between the control section 27 and the processing section 28. With many instructions there will be internal signal flow 29 going back to the control section 27 from the processing section 28. Flag signals, such as carry, negative, or equal are all generated within the processing section 28 and returned back to the decoder, 31 in FIG. 5 of 9, of the control section 27. The control section 27 will then set the signals on control lines of the auxiliary data/control bus 14 high or low in accordance with the flag signals.

When a DPU 26 is activated by the secondary address bus 12, full activation of the DPU does not occur. The secondary address bus 12 only causes activation of the processing section 28 of the DPU represented by the address on the bus. This activation of the processing section 28 is only for the reading or writing of data at the address indicated. The addressed DPU will also receive a control signal on the R/W control line indicating which operation, read or write, is to be performed. The reading or writing is to or from the data bus 13. The address that is put onto the secondary address bus 12 is always resident in the processing section 28 of a DPU. The processing section 28 holding that address is always in the DPU 26 that is adjacent to the DPU 26 that is active at that moment. One of several bilateral control lines, from the bilateral control bus 15, will cause the adjacent DPU to release the contents of its processing section 28 onto the secondary address bus 12.

The processing section 28 is composed of a series of bit positions. The number of bit positions in the processing section 28 represents the basic data size of the system. The data bus 13, the I/O bus 16, the primary address bus 11, and the secondary address bus 12 will all have the same number of bit lines as there are bit positions in the processing section 28. Refer to FIG. 6 of 9 except as noted. Each bit position of the processing section 28 consists of a one-bit arithmetic and logic unit, an ALU 32, and a data latch 33. Each ALU has three inputs, the ‘A’ input, the ‘B’ input, and a carry input. Only the ‘A’ input is used for many of the operations involving just one operand. Operations needing two operands will use the ‘A’ and the ‘B’ inputs. All three inputs are used for arithmetic operations that involve a carry from one bit position to another.

The ‘A’ input can receive input from the data bus 13 in FIG. 4 of 6, the I/O bus 16 in FIG. 4 of 6, or internally from a latch 33 via the data flow controller 34. The ‘B’ input can only receive input from the data bus except for the INC instruction. In the case of the INC instruction the ‘B’ input can receive an input from the data flow controller 34, but only for the two lowest bit value positions. The ALU 32 will use the input(s) to generate an output when directed to do so by the control section. For some operations, such as data movement operations and some others, the input merely passes through the ALU 32 to be output to the latches 33.
The output of each ALU 32 goes directly to a latch 33 that stores the result. The output of the latch 33 goes into the data flow controller 34. The data flow controller 34 is used to direct where the output from the latches 33 should go. It receives signals to guide its actions from the control section, 27 in FIG. 5 of 9, via the internal signal flow lines 29. Refer to FIG. 4 of 9. Possible destinations for the data from each latch include:
Output to the data bus 13, the I/O bus 16, the primary 11 or secondary 12 address buses, or the auxiliary data/control bus 14.
Output back to the ‘A’ input for use in another operation.
Output to the A input of an adjacent bit position for a shift operation.
Refer to FIG. 6 of 9. In addition to controlling the data flow the data flow controller 34 will also generate the flag signals that are sent back to the control section via the internal signal flow 29. The data flow controller has bit positions corresponding to the bit positions of the ALU 32 and latches 33. These bit positions will output to the corresponding bit lines of all the possible buses used for output.

The processing section 28 of a sequencing DPU is designed to hold data in its latches 33 just like a regular DPU. A sequencing DPU does not need all the processing functions that exist in a normal DPU. A sequencing DPU only needs to increment the address in its processing section or to accept input from the data bus as a new address. A sequencing DPU only outputs the address in its processing section onto the primary address bus, 11 in FIG. 4 of 9, to cause activation of the entire DPU thus addressed.

### Apportioning Switches—Function and Design

Refer to FIG. 1 of 9 except as noted. The function of apportioning switch blocks is to cause divisions in the apportionable bus structures. By causing divisions in the apportionable bus structures the switch blocks 18 will cause divisions within the entire set of DPUs. These divisions create groups of DPUs 10 within the entire set of DPUs. Because the bus structures are apportioned to create the smaller groups of DPUs 10, these groupings or smaller sets of DPUs, will become isolated from other similar groupings of DPUs 10 along with their own small section of the apportionable bus structures. Apportioning switch blocks 18 are designed to handle all the bit lines from one or more buses at the same time and are most common within the system. However, there are places within the design where single apportioning switches are appropriate. Interconnecting all the DPUs within the system are also bus structures that are not apportionable. These non-apportionable bus structures are not divided up in any way. Because of this, these non-apportionable bus structures still interconnect all the DPUs within all the separate groups of DPUs 10 that are otherwise isolated by the divisions in the apportionable bus structures.

The actual switches, 23 in FIG. 2 of 9, used for apportioning are constructed using MEMS (micro electrical mechanical systems) technology. The switches are designed to provide high isolation and low insertion loss. High isolation is needed to prevent signal interference between the different sections of an apportioned bus when the switches are in an opened state. Low insertion loss is needed when the switches are closed so that maximum continuity is provided for the signal on the bus. Each switch or bank of switches, 23 in FIG. 2 of 9, in an apportioning switch block 18 is programmable to be open or closed. They are set open or closed with software.

### Apportioning Switches—Method of Controlling the Switches

The operating system is in control of all apportioning switch blocks 18. The operating system uses the I/O bus 16 to address a particular switch or block of switches 18. Two of the global control lines in the global control bus 17 are used to set the switches to the proper state. The operating system has two instructions, opcodes, that are privileged, reserved for use by the operation system, that permit it to have total control over any and all apportioning switches or switch blocks. Refer to FIG. 2 of 9. The controlling circuitry for the switches 23 includes an address decoder 19, a switch state latch 21 to hold the state of the switches, and a switch driver circuit 22 to cause the switches 23 to change state.

The address decoder 19 accepts input from the I/O bus 16. This input is treated as the address of a switch or switch bank if the BASID control line 24 is high at the same time. If the address coming in on the I/O bus 16 matches the switch in question then the output of the address decoder 19 goes high. This high combined with a high signal on the BASID control line 24 will cause the output of the AND gate 20 to go high. The output from the AND gate 20 goes to the R/W input of the switch state latch 21. If the R/W input is in the write state then the output of the latch 21 will take the state, high or low, of whatever is on the BASS control line 25. The high or low signal on the BASS control line 25 represents the state that the switches 23 should take, either open or closed. The switch driver circuits 22 then use the output from the latch 21 to activate the switches 23 into the correct state.

Refer to FIG. 1 of 9 except as noted. Every bus line going into an apportioning switch block 18 located on an apportionable bus is opened or closed together. That is, all take the open state or all take the closed state. Each bit line is separate from all other bit lines on all of the buses that are apportioned at that switch bank. Therefore the number of switches, 23 in FIG. 2 of 9, in a switch block is equal to the number of bus lines being apportioned at that point. There are solitary apportioning switches in use at places within the system. This occurs on the SQM control line that is part of the global control bus 17. The global control bus 17 is not an apportioned bus but the SQM control line, a global control line, is divided up so as to be able to reach and affect any apportioned section within the system without affecting other apportioned sections. It has a tree-like structure and will have an apportioning switch located on every branch that leaves a node of the tree-like structure.

### Bus System—Function and Design

The function of the bus system is to provide for the interconnections between all the DPUs and other structures within the system. The apportionable part of the bus system also provides a means of dividing up the whole group of DPUs in the system into small groups of DPUs 10. This is done so as to provide each process that is running in the system its own group of DPUs 10 that are logically isolated from all other groups of DPUs 10. When the groups are logically isolated from each other then the process residing within each group is also logically isolated from every other process. This isolation is complete except for the interconnections between all DPUs provided by those bus structures that are not apportioned, the I/O bus 16 and the global control bus 17. Each isolated group of DPUs 10, an apportioned section, is composed of the DPUs logically located within it and that section of the apportioned bus structures that interconnects all the DPUs within that section. Also interconnecting every DPU within that section is the I/O bus 16 and the global control bus 17 which are also interconnecting every other DPU within the system.

When all apportioning switches are in a closed position, thereby causing no divisions in the apportionable bus structures, the bus lines in the system are then equally connecting all the DPUs within the system. In this state all DPUs are logically and equally connected to each other. The apportioned bus structures are then split into sections by the apportioning switch blocks 18 so that groups of DPUs become isolated from each other except for the two non-apportioned bus structures. The one exception to the apportionable and non-apportionable bus structures is the SQM control line in the global control bus 17. The SQM, sequence master, line is not apportioned like the other apportionable bus structures. Its structure is built like a branching tree structure and it will have one apportioning switch on each branch of its tree-like structure.

Since the apportionable bus structures cause a division of all DPUs within the system into two or more smaller groups of DPUs 10 several modifications are made to the address buses and their associated address decoding circuits. An apportioned section will have less than the total number of all possible addresses that exist within the system. This affects the number of address lines needed to address all DPUs within a particular apportioned section. Furthermore, because sections of the buses become isolated from each other the address decoder circuits are placed at various places along the address buses so as to be able provide decoding for apportioned sections and in some instances they are duplicated.

### Bus System—Apportionable Bus Structures

Refer to FIG. 4 of 9 except as noted. The apportionable bus structures are those that are divided into sections to cause divisions of all the DPUs into groupings of logically contiguous addresses. These include the primary 11 and secondary 12 address buses, the data bus 13, and the auxiliary data/control bus 14. The bilateral control bus 15 exists as a series of short sections between every pair of logically adjacent DPUs. There are almost as many short sections of this bus as there are DPUs within the system. While it does not need apportioning because of its structure, there is still a need to provide switches to sever the bus between sections of DPUs that are apportioned separately from each other. The apportionable buses include the following:

The primary address bus 11 is apportioned. The sequencing DPU uses it to activate an entire DPU 26. An address put onto the primary address bus 11 comes from the processing section 28 of the sequencing DPU.

The secondary address bus 12 is apportioned. It is used by a DPU that has been activated by the primary address bus 11 to cause activation of the processing section 28 of another DPU. This other DPU will have an operand needed for the operation being performed by the DPU that activated its processing section 28. The address put onto the secondary address bus 12 comes from the processing section 28 of a DPU that is adjacent to the DPU that was activated by the primary address bus 11.

The data bus 13 is apportioned. It is used for the transfer of data between the processing sections 28 of DPUs 26. Each processing section 28 can receive data as input from the data bus 13 and put data onto the data bus 13.

The auxiliary data/control bus 14 is apportioned. It is used for different purposes at different times. When a process is being loaded into a group of DPUs, 10 in FIG. 1 of 9, by the operating system, the auxiliary bus 14 is used for the transfer of data from the processing section 28 of a DPU to the control section 27 of another DPU. This bus is used to load the code into the control section 27 of DPUs. This can only be done by the operating system with the use of a privileged instruction. When the process has been loaded and starts to run in an apportioned section of DPUs then the auxiliary bus 14 is used only for local control signals. Local control signals that are meant only for the process within that section of DPUs are sent along the lines of the auxiliary bus 14. These control signals are as follows:
CF, the Carry Flag, is a control line that is part of the apportioned auxiliary data/control bus 14. This signal is only carried locally, within an apportioned section. The signal is either high or low in response to the last instruction that set it. An instruction that tests this line as part of its operation, a jump instruction, will cause the line to be reset.
EF, the Equal Flag, is a control line that is part of the apportioned auxiliary data/control bus 14. This signal is only carried locally, within an apportioned section. The signal is either high or low in response to the last instruction that set it. An instruction that tests this line as part of its operation, a jump instruction, will cause the line to be reset.
IOL, the Input/Output Line is part of the auxiliary data/control bus 14. It is used to enable or disable the DPU that is used to watch the I/O bus 16 for process ID tokens. The DPU that does this has the JMPIE instruction in its control section 27. The JMPIE instruction runs automatically each cycle of CLK2, checking the I/O bus 16 against the value held in the processing section 28. This signal on the IOL control line can disable or enable this automatic operation of the DPU with the JMPIE instruction.
NF, the Negative Flag, is a control line that is part of the apportioned auxiliary data/control bus 14. This signal is only carried locally, within an apportioned section. The signal is either high or low in response to the last instruction that set it. An instruction that tests this line as part of its operation, a jump instruction, will cause the line to be reset.
RW, the Read/Write signal, is a control line that is part of the apportioned auxiliary data/control bus 14. This signal is carried locally and is controlled by each DPU when the primary address bus 11 activates the DPU. The control section 27 of a DPU uses it to cause a processing section to read or write with the data bus 13.
SQ1, SQ2, and SQ3 are the three Sequence control lines. They are part of the apportioned auxiliary data/control bus 14 and their signals are only carried locally. These three signals are used together to provide information to the sequencer about the instruction in the currently active DPU. The information guides the sequencer in its next actions. Every DPU has access to these three sequence control lines. Each DPU that is not a sequencer will set these lines as part of its operation when activated by the primary address bus 11. However, only sequencing DPUs will respond to how these three control lines are set. Their response to the settings of the three control lines is as follows with the three lines providing for eight possible states:
   000—Normal sequencing. Increment address in sequencer by one.
   001—Normal sequencing. Increment address in sequencer by two.
   010—Jump without a return. Replace the address in the sequencer with a new address sent by the active DPU.
   011—Stop all sequencing. Process is terminated.
   100—Jump with a return. Increment the address in the sequencer by one. Then set the sequencer into standby sequence mode and make the next sequencer active. Bring the address to jump to into the new sequencer.
   101—UNUSED
   110—Retun from a jump. Set the sequencer into standby mode and make the previous sequencer active again.
   111—Finish current instruction and then set the sequencer to standby mode. Make the next sequencer active and accept address from the DPU containing the JMPIE instruction. The jump will be to a routine for input or output.

### Bus System—Bilateral Control Bus Lines

In addition to the other apportionable bus structures there are a group of control lines called the bilateral control lines collectively referred to as the bilateral control bus 15. These lines only go between adjacent DPUs. They do not form a continuous bus as the other bus structures do. They are used by the active DPU to signal an adjacent DPU, the DPU preceeding or following the active DPU, to read or write data to or from its processing section. When a group of DPUs 10 is apportioned these lines are also set open or closed on the first and last DPUs in each apportioned section to avoid contacts between DPUs of apportioned sections by the first and last DPUs in each section. These control lines are as follows:
APAR, the Adjacent Preceeding Auxiliary Read line causes the preceding processing section to release its data onto the auxiliary data/control bus 14.
AFDW, the Adjacent Following Data Write causes the following processing section to accept data from the data bus 13.
APDR, the Adjacent Preceding Data Read causes the preceding processing section to release its data onto the data bus 13.
AFAR, the Adjacent Following Address Read causes the following processing section to release its address onto the secondary address bus 12.

Two of these bilateral control lines are used within DPUs designed for sequencing. They are referred to differently to reflect their different use. When these two bilateral control lines are used with the sequencing DPUs they will activate the entire DPU, not just the processing section. The use of these control lines will actually change the opcodes in the involved DPUs, causing one to become the active sequencer and the other to switch to standby mode.
SSAF, the Sequence Stack Adjust Forward line activates the next sequencer in the sequencing stack to become the active sequencer.
SSAB, the Sequence Stack Adjust Back line activates the previous sequencer in the sequencing stack to become the active sequencer.

### Bus System—Non-Apportionable Bus Structures

Refer to FIG. 1 of 9. The bus structures that are not apportioned are those that do not have any apportioning switches along their lengths. These buses are not divided up in any manner and they still go to each and every DPU in the system. These include the I/O bus 16 and the global control bus 17.

The I/O bus 16 is not apportioned. It is used for all data transfer between a process isolated within an apportioned section of DPUs and all other processes within the system. Any and all data, excepting global control signals, coming into or leaving an apportioned section of DPUs will do so via the I/O bus 16.

The global control bus 17 is not apportioned. It is used for control signals that move freely throughout the entire system. The signals of the global control bus 17 are available in the same state and at the same time to all processes and DPUs within the system. As noted earlier the SQM control line of the global control bus is an exception. Its availability is system wide but it may be high or low in different partitioned sections depending on how the operating system has configured it. The global control signals are as follow:

BASS, the Bus Apportioning Switch State signal, is a global control signal. It is used to set the state of an apportioning switch or switch block 18. The line is set high or low to reflect the switch states of open or closed. This signal is accepted by a switch or switch block 18 while its address is on the I/O bus 16 and the BASID control line is high. This signal is available to every DPU and switch or switch block 18 within the system. It is controlled by the operating system and is set using a privileged instruction.
BASID, the Bus Apportioning Switch Identification signal, is a global control signal. It is used to signal an apportioning switch or switch block 18 that the data on the I/O bus 16 is a switch or switch block 18 address. This signal goes to every DPU and to every switch or switch block 18 within the system. The signal is controlled by the operating system and is set using a privileged instruction.
CLK1, the primary clock signal, is a global control signal. It is the basic timing signal within the system and is used to coordinate all functions within the system.
CLK2, the secondary clock signal, is a global control signal. Its signal is one tick for every two ticks of the CLK1 signal. It is used along with the CLK1 signal to facilitate the coordination of operations within the system.
CWE, the Code Write Enable signal, is a global control signal. It is used to signal an addressed DPU to accept the data from the auxiliary data/control bus 14 into its control section, 27 in FIG. 4 of 9. This signal is set by the operating system when it is loading code into a group of DPUs 10, an apportioned section. The signal is automatically generated as part of the movc instruction being used by the operating system.
PID, the Process Identification signal, is a global control signal. It is used to let all processes know that the data on the I/O bus 16 at that moment is a process identification number.
SQM, the Sequence Master signal, is a global control signal. This signal is used by the operating system to enable or disable all sequencing within processes. The sequence master signal on the SQM control line is implemented and changes state through the control of hardware by the operating system. As stated earlier, the SQM line has a branching tree-like structure with switches on each branch that exits a node of this tree-like structure. Setting the switch of a branch open or closed will cause the signal in that section to be made high or low. The signal is normally high throughout the control line and opening a switch cause that part of the line that has been severed to go low. All apportioned sections along the branch that now has a low SQM signal will receive the same low signal that will enable them to begin sequencing. By controlling this signal along the sections of the SQM control line the operating system can assert sequencing control in any apportioned section of DPUs and the process within that section.

### Set of Operations—Overall Design

Refer to FIG. 4 of 9. The set of operations are based upon the design and capabilities of the DPUs 26. The opcode for each operation is put into the control section 27. An operand is put into the processing section 28 for instructions needing one or two operands. In some cases the processing section 28 will hold the address of another operand. In cases where two operands are needed an adjacent DPU 26 will hold the address of the second operand in its processing section. If there is a storable result then it will usually be left in the processing section 28 of the DPU 26 performing the operation.

There are no alternative modes of addressing. There is only one way to use each opcode. Indexed addressing, address offsets, and all addressing modes except direct and indirect are achieved by operating on an address with multiple instructions. The opcode of an instruction cannot change once the sequencing of a process begins, except in the case of sequencing DPUs or a DPU containing the JMPIE instruction. This is not true for the processing section 28 of a DPU 26. All operands and other data reside in the processing sections of the DPUs apportioned for the process. They may be changed as frequently as needed by the program.

All of the instructions except one can be done in one or two clock cycles of CLK1. The one exception requires four clock cycles to complete. The CLK1 signal is used to cause the activation of the sub-operations of an opcode. The CLK2 signal is used to cause the sequencer to activate the next DPU for processing. Self-enabled or self-activated DPUs respond to the CLK2 signal but use the CLK1 signal to carry out the sub-operations of their opcode.

Refer to FIG. 7 of 9. To facilitate explanations for all the opcodes they have first been grouped into two basic groups, those common to the industry and those unique to this design. The details for each of the opcodes are presented in the following list that presents them in the order that they occur in FIG. 7 of 9. In all cases below the terms ‘address−1’ or ‘address+1’ represent the DPUs that logically precede or follow, respectively, the DPU holding the opcode in question. This is diagramed in the instruction formats at the bottom of FIG. 7 of 9.

### Set of Operations—Opcodes Standard of Industry

ADDC—Add with Carry—The processing section of the address holding the opcode holds the first operand. The processing section at address+1 holds the address of the second operand. The result will be left in the processing section of the DPU holding the opcode. Flag control lines will be set to reflect the result.
AND—Logical AND operation—The first operand is in the processing section of the DPU holding the opcode. The second operand is at the address in the processing section of address+1. The result will be left in the processing section of the DPU holding the opcode. Flag control lines will be set to reflect the result.
CMP—Logical XOR operation—The result is not saved but the flag control lines are set. The first and second operands are the same as in the ADDC instruction.
INC—Increment by one—The operand is in the processing section of the DPU holding the opcode and the result will be put in the same place. Flag control lines are set to reflect the result.
NOT—Logical NOT operation—The operand is in the processing section of the DPU holding the opcode. The result will be put in the same place. Flag control lines are set to reflect the result.
OR—Logical OR operation—The first operand is in the processing section of the DPU holding the opcode. The second operand is at the address found in the processing section at address+1. The result will be left in the processing section of the DPU holding the opcode. The flag control line will be set to reflect the result.
SL—Logical shift of one place to the left—The operand is in the processing section of the DPU containing the opcode. The flag control lines are set to reflect the result.
SR—Logical shift of one place to the right—The operand is in the processing section of the DPU containing the opcode. The flag control lines will be set to reflect the result.
XOR—Logical XOR operation—The result is saved and the flag control lines will be set to reflect the operation. The first operand is in the processing section of the DPU holding the opcode. The second operand is at the address in the processing section of address+1. The result will be left in the processing section of the DPU holding the opcode.
HLT—Halt program sequencing—No operand. The opcode causes the sequence control lines, SQ1, SQ2, and SQ3, to be set to the desired state to halt program sequencing. The opcode in the sequencer is changed from SEQ to SSEQ.
JMPC—Jump occurs if the CF, carry flag, control line is set—The jump is to the address that is in the processing section of the DPU holding the opcode. If the jump fails the next operation is at address+1. If the jump succeeds the new address is put onto the data bus and accepted into the processing section of the active sequencer. There is no return.
JMPCR—Jump occurs if the CF control line is set—This is the same as the JMPC instruction except that there is to be a return from the jump. The active sequencer is deactivated after incrementing the address in its processing section by one. The next DPU in the sequencing stack is activated. The address in the processing section of the DPU holding the opcode is transferred to the newly activated sequencer. The return address is still in the previous sequencer and processing will recommence there when the previous sequencer is reactivated by a RET instruction.
JMPE—Jump if the equal flag, EF, control line is set—The sequence of events for this instruction are the same as in the JMPC instruction. However, the condition is whether or not the EF, equal flag, control line is set. This instruction and the following instruction, JMPER, require the use of the CMP instruction somewhere in the code preceding these two instructions. The EF control line can only be set as a result of the CMP instruction.
JMPER—Jump if the equal flag control line is set. A return from the jump is necessary—This is like the JMPCR instruction except that the condition is whether or not the EF, equal flag, control line is set.
JMPN—Jump if the negative flag, NF, control line is set—This instruction is like the JMPC and the JMPE instructions except that the condition is the negative flag control line being set or not.
JMPNR—Jump if the negative flag, NF, control line is set—This one is like the JMPCR and the JMPER instructions except that the condition involves the NF control line.
JMPU—Jump unconditionally—No flag control line is checked, nor is a return possible. The address in the processing section is transferred to the sequencer and sequencing commences at the new address.
NOP—No operation performed—All DPUs not containing another opcode will have this opcode in their control section.
RET—Return from a jump—This opcode sets the sequencing lines, SQ1, SQ2, and SQ3 to the correct state to affect an adjustment in the sequencing stack. The current sequencer is deactivated and the previously active sequencer is reactivated. It still contains the address of the next DPU to activate before the last jump occurred.

### Set of Operations—Opcodes Unique to this Design

INP—Accept one set of parallel bits off of the I/O bus lines—The bits are left in the processing section of the DPU containing the opcode.
IOLS—Input/Output Line Set—The IOL control line is set high or low depending on what is in the processing section of this DPU. Setting the IOL control line high or low is done to enable or disable the DPU containing the JMPIE instruction. When the IOL is high the DPU holding that instruction will be self-enabled to do its operation with each tick of CLK2. If it is low then the DPU holding the JMPIE instruction is in a standby mode.
JMPIE—Jump if Input is Equal—The operand to be compared is in the processing section. The other operand is accepted as input from the I/O bus. If the PID control line is high when as the input occurs, then a logical XOR operation is performed. If the equal flag is set as a result of the operation then other actions occur. If the IOL control line is high then this DPU is in a self-enabled mode causing it to make the comparison every tick of the CLK2 signal. If its jump conditions are met then it will set the sequence control lines to a state which causes the sequencer to finish its current instruction and then let a jump occur to the address in the processing section of address+1. There will be a return so an adjustment in the stack will also occur. This instruction must let any current instruction finish before initiating a jump so it needs four clock ticks of CLK1 to perform.
MOVH—Move an operand to this address+1—The address of the operand is in the processing section of the DPU with the opcode. The operand that is moved is put into the processing section of address+1.
MOVT—Move an operand from address−1 to the address contained in the processing section of the DPU holding the opcode.
OUT—Put a set of parallel bits onto the I/O bus lines—The bits to put onto the I/O bus are in the processing section of the DPU with the opcode.

The next three opcodes are designed to work only in sequencing DPUs and sequencing DPUs will only function with these three instructions. Sequencing DPUs are designed to be part of the sequencing stack. The sequencing stack is implemented with a combination of software and hardware. It is used to control program flow and the order of instruction activation. One sequencing stack exists in each apportionable section. They are composed of a series of DPUs designed solely for the three sequencing opcodes. At the end of each instruction cycle the processing section of the active sequencer will contain the address of the next DPU to activate. Only one DPU is the active sequencer, contains the SEQ opcode, at any one time. All other sequencing DPUs contain the SSEQ opcode, the opcode for a standby sequencer, except the first and last sequencing DPUs in the sequencer stack. The first and last in the stack contain the SEQSL opcode which, if activated as a normal part of sequencing operations, will cause a jump to a stack limit error routine and eventual shutdown of the process.
SEQ—This is the opcode of the active sequencer—The next address to activate for processing is in the processing section of the DPU with the SEQ opcode. As each address is activated the sequencer receives signals on the sequence control lines, SQ1, SQ2, and SQ3 indicating whether to increment its address by one or two. It may also receive signals indicating jump conditions, or to alter its sequencing status. It can only sequence instructions when the operating system has caused the SQM control line to go low in that local section containing that SEQ instruction.
SSEQ—Standby sequence mode—This opcode is for all members of sequencing stack, except the first and last sequencing DPUs, and the DPU that is the active sequencer. They may be activated in turn by having their opcodes modified by signals from the active sequencer via the SSAF or SSAB bilateral control lines.
SEQSL—Sequencing Stack Limiter—Placed at the beginning and end of the sequencing stack this instruction contain an address to jump to in case they are activated via the SSAF or SSAB bilateral control lines. The jump is to a routine that outputs an error message and then causes a halt to all sequencing within the process. An unrecoverable error has occurred.

### Set of Operations—Privileged Opcodes

The use of these opcodes is restricted to the operating system. This is done for system security and stability.
BASIS—Bus Apportioning Switch Identification Line Set—This opcode causes the BASID control line to be set high or low depending on the operand in the processing section of the DPU with the opcode. The BASID control line is set high when an apportioning switch or switch block ID number is being put onto the I/O bus. This signals the switch blocks that the data on the I/O bus should be checked as an address.
BASSS—Bus Apportioning Switch State Set—This opcode set the BASS control line high or low depending on the contents of the processing section of the DPU with the opcode. This control line sets a selected switch or switch block open or closed for apportioning purposes.
MOVC—Move Code—This instruction is used to move opcodes into the control section of DPUs. It will cause the contents of a processing section to be output onto the auxiliary data/control bus. The address receiving the code is in the processing section of address−1.
PIDLS—Process Identification Line Set—This instruction is used to set the PID control line high or low as needed. When the PID control line is high it signals to all processes that the data on the I/O line is a process identification number. Any active DPU containing the JMPIE instruction will be watching the I/O bus for data in conjunction with this signal.

### Supporting Structures

While the DPUs, bus structures, and apportioning switches are sufficient for accomplishing all of the processing, memory, and control functions needed within this system there are several support structures that are needed to complete the system and to make it fully functional. The most important of these are mentioned below.

All computer systems need a basic set of instructions that help the system to boot up and get started. In this system this will be accomplished by a set of DPUs that have the opcodes already loaded into them. Mentioned earlier as two of the four types of DPUs within the system, these DPUs would be programmed before their installation within the system but would not programmable while installed. They will be activated when power is applied to the system and will function to get the system started and begin the installation of the remaining parts of the operating system.

All four types of DPUs used within the system will need to address other DPUs. The two address buses designed for this purpose, the primary and secondary address buses, both need decoders to be able to address each and every DPU within the system. Both of the address buses are apportionable. Apportioned sections will always have less than the total of all the DPUs in the system. The address buses are designed to handle any address on their bit lines. While the lines with higher bit values will often be left unused in an apportioned section, the lines with lower bit values will be needed for addressing. Since they are divided the address decoding circuits are modified and duplicated in places to accommodate the situation.

Other support structures needed include clock circuits, and a power supply. There are two clock signals used within the system. The second clock signal is one tick for every two ticks of the primary clock. The first is used for timing individual actions while the second signal provides timing for sequencer operations. The power supply is needed to provide power to all circuits. Because the systems' resources are apportioned and so thoroughly distributed it is possible to shut down unused portions of the system without affecting those other portions that are in use. The power circuits are designed to take advantage of this opportunity.

OPERATION

The basic operation of this system will be described starting from being turned on, through boot up, the loading of processes into partitioned sections, multiple processes running simultaneously and ending with a process terminating.

With power applied to the system one of the first control signals to appear will be the SQM signal in a high state. This signal will suppress any and all possible SEQ instructions that may have randomly occurred with power applied to the DPUs within the system. The BIOS, built into a set of DPUs that are not software programmable, will start functioning. It will establish the basic structure within the first partitioned section, laying the foundations of the operating system. The operating system will continue to be established as data is brought into the DPUs from a secondary storage device and various system checks are made and parameters set. This will continue until the operating system is fully established.

Once the operating system has been established, the system will consist of one or more apportioned sections established as belonging to the operating system, which includes the I/O system, and the rest of the system which is all the other apportionable sections. The rest of the system is all other DPUs within the system that have not been set aside for the operating system at this time. Data structures established within the operating system will include an array of all possible sections of DPUs that are apportionable, an array of all possible apportioning switches along with their possible settings, the beginnings of an array of process indentification numbers and other information relating to these structures within the system.

At this point the operating system is ready to begin loading other processes for execution within the system. To accomplish this it will begin by locating a process within secondary storage and retrieving information regarding the process. This information will enable the operating system to assign a process id and to assign one or more apportionable sections to the process. Using information contained within the data structures built for the purpose the operating system will set various apportioning switches within the system to isolate that apportioned section of DPUs assigned to the process.

Having set aside the necessary DPUs to provide the process the needed space within the system it will begin to load the process into that section. Part of the loading process will include retrieving information on the I/O needs of the process. This will be stored within the data structure used by the I/O system for I/O control. This process will continue until the process has been fully loaded. Part of the loading process may require other processes to temporarily stop while the buses are used to transfer data along to the space assigned to the process being loaded. This may require temporarily setting various apportioning switches to various configurations.

Another part of the loading process is to check the validity of the code that is being loaded. Each piece of code is checked for being a valid opcode before it is put into the code section of a DPU. The code is also checked to be sure that it is not a privileged opcode going to any other process other than the operating system. I/O needs are also validated against the code being put into the process. Once the process has been fully loaded the operating system will set the SQM control line to the new process low so as to let the process begin execution. Letting the SQM line go low will permit the sequencer within that section to begin sequencing of instructions. At this point the process is isolated within its apportioned section and cannot be affected by any other process, except the operating system. Furthermore it cannot affect any other process within the system. The only way for the process to communicate with any other process is by using the I/O system.

The I/O system has been designed to permit and facilitate the transfer of data between all processes within the system. Except for possible control signals along the lines of the Global Control bus and the transfer of data along the I/O bus all processes are isolated from each other. This isolation has been accomplished by the operating system settings of the apportioning switches. Because of this isolation between all processes every process has a process identification number and equal access to the I/O bus.

Even though all processes have equal access to the I/O system they do not have unlimited access. A strict protocol structure is used to control output to the I/O system. Input to every process is unlimited. A process merely has to watch what is on the I/O bus and then to take that data as input when it chooses to do so. Output is not so freely done. Each process, when loaded into its apportioned section, provided information to the I/O system. This information detailed what needs the process might have for output onto the I/O bus. This information, along with similar information from all other processes, was used to formulate how much time to allot to the process for its output needs.

The I/O system will inform each process when its turn has come to put data onto the I/O bus and exactly how much data it is permitted to output. This is necessary to avoid conflicts among all processes using the I/O bus. The I/O system is monitoring the use of the bus by each process and the failure of a process to abide by the protocol will cause a termination of the process. The I/O system, part of the operating system, has ultimate control over a process by use of the SQM control line.

A process that terminates normally will inform the operating system of its termination before doing so. This termination notice is sent to the operating system via the I/O bus. After sending the termination signal a process will use the HLT instruction as the last instruction. The HLT instruction will set the sequence control line to the proper state to halt sequencing within the process. At this point the operating system will readjust the apportioning switches to reclaim the DPUs within the apportioned section that is no longer used by the terminated process. The operating system will also update its array of data concerning apportionable sections so as to make that space available to another process.

In cases where a process has faulted to a non-functioning state it will have done so through use of an error routine or abnormally. A routine for an unrecoverable error will have a HLT instruction as its last instruction and will have notified the operating system of its termination. Abnormal termination will result in the process running rampant in error mode within its section. This may affect how the process uses the I/O bus and this will be detected by the I/O system. In this case the I/O system will terminated the process. It is possible that software not design to catch all errors will fail to cause a termination of the functioning process. In this case the process may continue running within its apportioned section without notice by the operating system so long as it is not interfering with other processes.

### Alternate Embodiments

There are two separate parts of the system, as it has been detailed so far, where an alternate design might be of benefit. One deals with the DPUs within the system that are used for the JMPIE instruction. The other deals with the apportionable bus structures using an alternate mode of addressing that could provide real benefits.

So far mention has been made of four different types of DPUs used within the system. These include the regular DPUs, the DPUs used for the sequencing stack, and the additional two types that are derived from these two basic types by making them non-programmable within the system. There are possible benefits to adding a fifth type to the system. Every apportioned process within its own section needs a DPU to perform as a sentinel over the I/O bus. This function is handled by a DPU with the JMPIE instruction. This instruction causes self-activation of the DPU provided that the IOL line is set high. Because it is present in every process it could be advantageous to construct one, and possibly include a second as a backup, within every apportionable section. It need not be programmable or include many of the functions of a normal DPU. A savings could possibly be gained in this manner.

The second alternate design embodiment involves using the primary address bus to activate numerous DPUs within a single process simultaneously. This can be advantageous in processes that handle matrices or large arrays of data that require an operation be performed on every piece of a large set of data. As mentioned earlier there are unused address lines that occur whenever an apportioned section has only a small part of the total DPU space that is available. These unused lines can be put to use when combined with the addition of some additional address decoding circuitry to develop an additional addressing mode. This mode will require the use of an additional local control line, some additional circuitry, and an additional instruction. These additional elements in the design will enable the activation of multiple DPUs simultaneously.

### ADVANTAGES

From the details given a number of advantages of this method of design become apparent:
A full integration of memory, processing, and control has been achieved.
A full and complete decentralization of system resources has been achieved.
System resources are apportionable among multiple processes running simultaneously.
The possibility of easily expanding system resources has been achieved.
An almost unlimited potential to increase system throughput has been achieved.
A tremendous increase in system and process security has been achieved.
System and process stability has been increased.
System complexity has been significantly decreased.
The potential for uniformity and standardization within the industry has been increased.
The potential for system and application programming standardization has been increased.

### CONCLUSION

Details have been given on a method of designing a computer architecture that will provide solutions to many of the problems facing the industry at this time. The method presented shows an architecture that is completely decentralized with computing resources uniformly distributed throughout the system. The addition of a method of apportioning these resources amongst different processes leads to a system in which multiple processes can be running simultaneously without conflict.

Such a completely decentralized architecture combined with the ability to apportion sections of it out to different processes offers numerous benefits. Some of these include an almost unlimited potential to increases system throughput, a substantial increase in system security and stability, and decrease in system complexity. Not so obvious, but still very real, is the tremendous potential for innovation within the industry by the introduction of this design which overcomes many of the difficulties being encountered in the search for greater throughput within systems.

Despite the many specific details provided in the foregoing pages, they should not be taken as limitations on the scope of the invention. Rather they should be seen as examples of a preferred embodiment of this invention. With any system of such complexity there are many variables to consider when it comes to the actual development of a product. For example, the set of operations has many possible forms, one of which can only be decided upon when viewed under conditions of product development. Therefore the scope, and the limitations of such scope, should be determined by the claims that are presented.

1. A method of designing a computer system having a completely decentralized processing architecture comprising;
a. a set of operations which require zero or more operands and will produce a result that can be stored or will cause an action to occur,
b. a multitude of decentralized processing units which are composed of a control section and a processing section and which are software programmable to do any one operation from said set of operations and which are capable of holding one said operand for, or said result of, said operation,
c. a bus system which interconnects all said processing units so that each said processing unit can be uniquely addressed and which has some bus structures that are apportionable and other bus structures that are not apportionable,
d. a means of apportioning said apportionable bus structures so as to form groupings of said processing units that are logically separated from all other said groupings except for the interconnections between said processing units provided by said bus structures that are not apportionable.
